(19) United States
(12) Patent Application Publication
(10) Pub. No.: US 2019/0246623 A1
(43) Pub. Date: Aug. 15, 2019

(54) PEST DETERRENT SYSTEM

(71) Applicant: Commonwealth Scientific and Industrial Research Organisation, Australian Capital Territory (AU)

(72) Inventors: Ashley TEWS, Australian Capital Territory (AU); Philip VALENCIA, Australian Capital Territory (AU)

(21) Appl. No.: 16/315,022

(22) PCT Filed: Jul. 6, 2017
(86) PCT No.: PCT/AU2017/050700

§ 371 Date: Jan. 3, 2019

(30) Foreign Application Priority Data
Jul. 8, 2016 (AU) 2016902680

(51) Int. Cl. A01M 29/00; A01M 31/00; A01M 29/16; A01M 29/10; G05B 15/02

(52) U.S. Cl. CPC A01M 29/00; A01M 31/002; G05B 15/02; A01M 29/10; A01M 29/16

(57) ABSTRACT

A pest deterrent system including at least one processing device that determines a presence of a pest in accordance with sensor data from at least one sensor, determines a deterrent strategy, causes at least one deterrent to be activated in accordance with the deterrent strategy, monitors a response of the pest to the activated deterrent in accordance with sensor data from at least one sensor, and selectively modifies the deterrent strategy in accordance with the response of the pest.

### BACKGROUND OF THE INVENTION

The present invention relates to a pest deterrent system and method and in one particular example to an adaptive pest deterrent system and method.

### DESCRIPTION OF THE PRIOR ART

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

It is known to use deterrents in order to deter pests for a range of purposes, such as protecting crops and livestock. Traditional deterrents have included static objects, such as decoys or scarecrows, which are used to mimic a predator or threat to the pest, thereby deterring the pest from the vicinity of the relevant area under protection. More recently, these have been replaced by or combined with other deterrents, including mechanical devices, such as windmills, and electronic systems, such as lights, sounds, ultrasound based systems or the like.

However, such systems typically suffer from a limited effectiveness. In particular different pests react differently to different deterrents, and hence the use of only one or two deterrents may not be sufficiently effective against a range of different pests. Furthermore, pests often become accustomed to the presence of the deterrent, meaning the deterrent can lose effectiveness over time.

There is therefore a need for an improved pest deterrent system.

### SUMMARY OF THE PRESENT INVENTION

In one broad form the present invention seeks to provide a pest deterrent system including at least one processing device that:
a) determines a presence of a pest in accordance with sensor data from at least one sensor;
b) determines a deterrent strategy;
c) causes at least one deterrent to be activated in accordance with the deterrent strategy;
d) monitors a response of the pest to the activated deterrent in accordance with sensor data from at least one sensor; and,
e) selectively modifies the deterrent strategy in accordance with the response of the pest.

Typically the system includes:
a) a plurality of nodes, each node including:
   i) at least one node sensor for use in sensing a pest; and,
   ii) at least one deterrent for use in deterring a pest; and,
b) a hub in communication with the nodes, the hub including the at least one processing device.

Typically the pest deterrent system is adapted to protect an area of land and wherein the nodes are at least one of:

a) spaced throughout the area; and,

b) spaced along at least part of a boundary of the area.

Typically each node includes a node processing device that:
a) detects a trigger indicative of a potential pest in accordance with signals from the at least one node sensor; and,
b) provides a trigger indication indicative of the presence of the potential pest to the hub.

Typically the node processing device:
a) determines a location of the potential pest using the sensor data; and,
b) generates the trigger indication in accordance with the location of the potential pest.

Typically each node includes a node processing device that, in response to instructions from the hub selectively activates at least one deterrent.

Typically the hub includes a hub processing device, and wherein the hub processing device:
a) determines at least one of a presence and location of a pest at least one of:
   i) using sensor data from at least one hub sensor; and,
   ii) at least partially in accordance with a trigger indication received from a node; and,
b) generates instructions to cause nodes to selectively activate at least one deterrent in accordance with at least one of the presence and location of the pest.

Typically the hub processing device:

a) determines a location of each of the nodes; and,

b) uses the location of the nodes to at least one of:
i) determine a location of a pest; and,
ii) selectively activate deterrents.

Typically the hub processing device determines a location of each of the nodes by at least one of:

a) retrieving a defined location from a store;

b) receiving an indication of a location from the node; and,

c) sensing a location of each of the nodes.

Typically the hub communicates with the nodes via a wireless mesh network established using the nodes.

Typically the hub includes at least one hub sensor for use in sensing a pest or non-pest.

Typically the hub sensor is a movable sensor, and wherein a hub processing device:

a) determines a location of the pest; and,

b) controls the movable sensor in accordance with the location of the pest.

Typically the at least one processing device determines sensed parameters from the sensor data, the sensed parameters including at least one of:

a) a pest size;

b) a pest shape;

c) a pest colour;

d) a pest thermal signature;

e) a pest movement;

f) a pest velocity;

g) a pest acceleration;

h) a pest location;

i) a pest number;

j) a pest concentration; and,

k) a pest response.

Typically the at least one processing device determines a pest type by:
a) generating a pest signature using at least one sensed parameter derived from the sensor data;
b) comparing the pest signature to a number of reference signatures indicative of the identity of respective pests; and,
c) determining a pest type in accordance with results of the comparison.

Typically the at least one processing device:
a) determines a pest type; and,
b) determines the deterrent strategy at least partially in accordance with the pest type.

Typically the at least one processing device:

a) retrieves one of a number of deterrent templates from a data store; and,

b) determines the deterrent strategy using the deterrent template.

Typically each template is associated with a respective pest type and the at least one processing device:
a) retrieves the deterrent template in accordance with the determined pest type; and,
b) determines the deterrent strategy using the deterrent template and at least one sensed parameter derived from the sensor data.

Typically the at least one processing device selectively modifies the deterrent strategy by modifying the deterrent template.

Typically the at least one processing device retrieves the deterrent templates from at least one of:

a) a local store; and,

b) a remote store.

Typically a number of hubs are configured to share deterrent templates via the remote store.

Typically the at least one processing device:
a) stores response data indicative of a response of a pest to a particular deterrent strategy; and,
b) modifies the deterrent strategy using the response data.

Typically the at least one processing device modifies the deterrent strategy using response data for a number of different responses of pests of the respective pest type.

Typically the processing device modifies the deterrent strategy using at least one of:

a) adaptive learning;

b) machine learning;

c) parameter modification; and,

d) genetic algorithms.

Typically the at least one sensor includes at least one of:

a) a thermal sensor;

b) a hyperspectral sensor;

c) a laser range finder;

d) an imaging device;

e) a proximity sensor;

f) a radio receiver;

g) a motion sensor; and,

h) an acoustic signal sensor.

Typically:

a) at least one hub sensor includes at least one of:
i) a thermal sensor;
ii) an imaging device;
iii) an acoustic signal sensor; and,
iv) a radio receiver; and,

b) at least one node sensor includes at least one of:
i) a proximity sensor; and
ii) a motion sensor.

Typically the at least one deterrent includes at least one of:

a) an acoustic signal generator;

b) a light source;

c) a motion generator; and,

d) a request for human presence.

Typically the deterrent strategy defines at least one of:

a) an acoustic signal type;

b) an acoustic signal location;

c) an acoustic signal sequence;

d) a motion type;

e) a motion location;

f) a motion sequence;

g) a motion object;

h) an illumination type;

i) an illumination location;

j) an illumination sequence; and,

k) a request for human presence.

Typically the at least one processing device causes the at least one deterrent to be activated in response to determining the presence of a predetermined number of pests.

In one broad form the present invention seeks to provide a pest deterrent method including, in at least one electronic processing device:
a) using sensor data from at least one sensor to determine a presence of a pest;
b) determining a deterrent strategy;
c) causing at least one deterrent to be activated in accordance with the deterrent strategy;
d) using sensor data from the at least one sensor to monitor a response of the pest to the activated deterrent; and,
e) selectively modifying the deterrent strategy in accordance with the response of the pest.

Typically the method includes:
a) providing a plurality of nodes within an area to be protected, each node including:
   i) at least one node sensor for use in sensing a pest; and,
   ii) at least one deterrent for use in deterring a pest; and,
b) providing a hub in communication with the nodes, the hub including at least one processing device.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which: —

FIG. 1 is an example of a pest deterrent method;

FIG. 2 is a schematic diagram of an example of a pest deterrent system;

FIG. 3A is a schematic diagram of an example of the hub of FIG. 2;

FIG. 3B is a schematic diagram of the physical configuration of the hub of FIG. 2;

FIG. 4 is a schematic diagram of an example of a node of FIG. 2;

FIG. 5 is a schematic diagram of an example of a processing system of FIG. 2;

FIG. 6 is a schematic diagram of an example of a client device of FIG. 2;

FIG. 7A is a schematic diagram of a first example of sensor fields of view;

FIG. 7B is a schematic diagram of a second example of sensor fields of view;

FIG. 7C is a schematic diagram of a third example of sensor fields of view;

FIG. 8 is a flow chart of a first example of node operation; and,

FIGS. 9A to 9C are a flow chart of a specific example of a method for deterring pests.

### DETAILED DESCRIPTION OF THE PREFERRED EMBODIMENTS

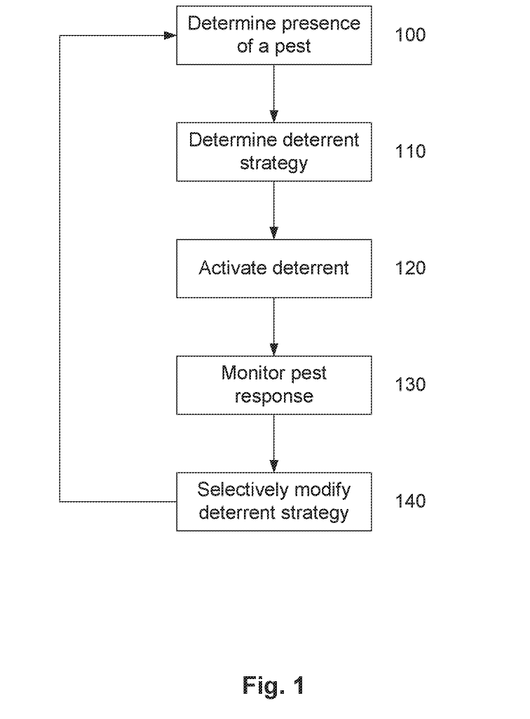

An example of a method for deterring pests will now be described with reference to FIG. 1.

For the purpose of this example, it is assumed that the method is performed at least in part using one or more electronic processing devices. The processing devices can form part of one or more processing systems and may be integrated into, distributed between, or in communication with hubs and nodes, and optionally any associated controllers, as will be described in more detail below. The one or more electronic processing devices are typically in communication with at least one sensor and at least one deterrent, allowing the one or more processing devices to use sensor data to determine the presence of pests and then use this to selectively activate deterrents.

In this example, at step 100 the processing device determines a presence of a pest in accordance with sensor data from at least one sensor. In this regard, the nature of the sensor data, and how this interpreted to determine the presence of the pest will vary depending on the type of sensor being used. The sensors could include thermal sensors, hyperspectral imagers, laser range finders, imaging devices, proximity sensors, radio receivers, motion sensors, acoustic sensors or the like, and hence the sensor data could include images, acoustic signals, thermal signatures, proximity indications or the like. The manner in which the sensor data is used to determine the presence of a pest will vary depending on the data. Hence in the case of a proximity indication, this could be inherently indicative of the presence of a pest or potential pest, whereas images or acoustic signals may require analysis in order to identify specific patterns or particular changes in the sensor data, allowing a presence of a pest to be determined. In one example, radio receivers may be used to determine a presence of a pest using radio tomography. As will be appreciated from the following description, the above example sensors and sensor data are intended to be illustrative and should not be considered as limiting as any suitable sensor could be used. The processing device(s) may receive sensor data directly from the sensor and/or could receive an indication of a pest or potential pest derived from sensor data from a sensor, as will be described in more detail below.

At step 110 the at least one processing device operates to determine a deterrent strategy. The deterrent strategy could be of any appropriate form but typically specifies one or more particular deterrents that are to be activated and optionally an associated sequence and/or pattern of activation. For example, the deterrent strategy could indicate that certain audible acoustic signals are to be produced, such as individual tones, simulated or recorded animal calls or the like. The deterrent strategy could also indicate that these are to be activated in a particular order, at set time intervals, in particular locations, or the like. The deterrent strategy could also indicate that different types of deterrent, such as acoustic and visual deterrents are to be used either alone or in combination.

At step 120 the processing device causes at least one deterrent to be activated in accordance with the deterrent strategy. In this regard, the processing device can activate the deterrent directly, or alternatively can generate instructions, causing another processing device, such as a controller or the like, to activate the deterrent as required.

At step 130 the at least one processing device monitors a response of the pest to the activated deterrent in accordance with sensor data from the at least one sensor. Again, sensor data could be received directly from the sensor, or alternatively an indication of the pest response could be derived from sensor data and provided to the processing device(s). Thus, using sensor data or indications derived from the sensor data, the processing device(s) will determine if the deterrent has been successful, for example by detecting movement (or a lack of movement) of the pest out of an area under protection, or by determining other behavioural and/or physiological responses. The processing device(s) could determine the response in terms of a degree of success, which could be a discrete measure, such as a successful, partially successful or not successful indication. Alternatively, this could be a continuous measure, depending on the nature of the sensing performed and/or the preferred implementation.

At step 140 the at least one processing device selectively modifies the deterrent strategy in accordance with the response of the pest. Thus, if the deterrent strategy has been successful at deterring the pest, no change to the strategy may be required. Alternatively, if the strategy was unsuccessful or only partially successful, for example if some pests remain, then the strategy can be modified so that a different strategy is used in future and/or so that additional steps are performed to deter remaining pests. The strategy may also be modified even if it has been successful, for example if it has already been used a predefined number of times, to thereby help avoid pests becoming accustomed to the deterrents, and hence maintain effectiveness.

The manner in which the deterrent strategy is varied will depend on the preferred implementation. This could include changing individual deterrents, for example to alter a type of acoustic signal which is produced and/or could include altering sequences or patterns of deterrents, such as changing the order in which particular deterrents are activated, adding additional deterrents to a sequence, activating deterrents at different locations, using different acoustic signals or lights, or the like.

In any event, it will be appreciated that the above described arrangement provides an adaptive system that is capable of changing deterrent strategies based on the response of pests to particular deterrents. By modifying the deterrent strategies used in an appropriate manner, this can help improve the effectiveness of the strategy used. Additionally, as this allows strategies to be modified dynamically, the deterrent strategies will change adaptively over time, to thereby prevent pests being accustomed to particular strategies, thereby ensuring the deterrent system is effective over prolonged periods of time.

A number of further features will be described.

In one example, the system includes a plurality of nodes, each of which includes at least one node sensor for sensing a pest or potential pest and at least one deterrent for deterring a pest. The plurality of nodes are typically arranged within an area being protected and are provided in communication with a hub, which includes at least one hub processing device.

For the purpose of the following description, the term “processing device” is taken to refer to a processing device anywhere within the system, whilst reference to the terms “hub processing device” and “node processing device” are taken to refer to processing devices located in the hub or the node respectively.

In any event, the use of the hub and node configuration can provide a number of additional benefits.

Firstly, the use of a hub and node configuration can be used to ensure adequate sensor and deterrent coverage over a large area. For example, if the system is being used to protect an area of land, such as one or more fields of crops, this allows the nodes to be spaced throughout the area and/or positioned along part or all of a boundary of the area, thereby providing effective sensor and/or deterrent coverage for the whole area or at least key parts of the area, such as boundaries through which pests enter the area. Despite this, a single hub can be used to provide centralised control, and in particular to determine the presence and/or location of pests and to control the activation of deterrents of each of the nodes. This in turn increases the effectiveness of the sensing process, whilst allowing deterrents to be activated in a coordinated fashion, enabling a wide range of deterrent strategies to be implemented across the area as required.

Secondly, the use of a centralised hub allows more sophisticated processing and control to the implementation, including allowing for discrimination and/or classification of pests, so as to distinguish between pest and non-pest animals, as well as different types of pest, allowing the use of deterrents to be targeted to specifically at particularly types of pest, thereby increasing the effectiveness of the deterrents, and avoiding the unnecessary use of deterrents on non-pest animals.

Thirdly, this allows the nodes to be implemented using only limited processing capabilities, with the majority of processing, such as the determination and modification of deterrent strategies, being performed elsewhere, such as in the hub or other processing systems connected to the hub. As a result, nodes can be manufactured more cheaply, and use less power, allowing these to be operated by battery and/or renewable power sources, such as solar power or the like. This allows the nodes to be easily distributed within the area being protected, without requiring complex installation, such as the addition of wired power supplies. However, as previously mentioned, processing can be distributed between the hubs and nodes in a variety of manners depending on the preferred implementation, meaning that nodes could perform discrimination or classification of pests, allowing these to be implemented independently of, and hence in absence of a hub, in some circumstances.

In some implementations the nodes may include sufficient processing capabilities to allow classification and decision making functionalities to be performed by the nodes. In some examples, the nodes may be configured to communicate to other nodes to facilitate distributed processing functionalities across the nodes. It will be appreciated that this may enable the nodes to collectively perform, in a distributed manner, more computationally intensive tasks than the nodes may be capable of performing individually. This distributed processing functionality may allow the system to operate without the need for a hub. Inter-node communication may be used not only to enable distributed processing, but to also allow for communication of information regarding detection of potential pests or sharing of modifications to the deterrent strategy.

A number of other power saving measures can be utilised in order to further reduce power usage in the nodes. In this regard, the nodes are typically wirelessly connected to the hub and so communication between the node and the hub can represent significant energy expenditure. In order to minimise this, the nodes are typically adapted to minimise communication with the hub by only forwarding sensor data and/or indications of the presence of pests or potential pests when needed, such as when potential pests are detected or when instructed by the hub.

In this regard, the node processing device can include a proximity and/or motion sensor, which can detect the presence of a trigger indicative of a potential pest. In this instance, if the presence of a potential pest, such as an animal is detected, the node processing device can forward a trigger indication to the hub, alerting the hub to the presence of a potential pest. Additionally, or alternatively, if sensors collect more detailed information, such as by imaging pests, sensor data could be provided instead of, or in addition to, the indications. In any event, sensor data and/or indications are only provided as needed, allowing the node to reduce the amount of communication required with the hub, thereby minimising power usage. Whilst the trigger indication could simply be indicative of the presence of the potential pest, in one example, the node processing device can determine a location of the potential pest relative to the node, for example by determining in which of a number of different sensor fields of view the potential pest is detected, in which case the trigger indication can be indicative of the presence and relative location of the potential pest. It will also be appreciated that other localisation techniques could be used, such as using radio tomography based on a distance of a pest from multiple nodes. Furthermore, it will be appreciated that the location of the potential pest may be determined in a local or geographic reference. In one example, the location may be determined using one or more Global Positioning System (GPS) receivers, which may be included in the nodes and/or the hub.

The hub, and in particular the hub processing device is responsive to trigger indications, sensor data from node sensors, and/or sensor data from hub sensors, to determine a presence and/or location of a pest and then generate instructions to cause nodes to selectively activate at least one deterrent in accordance with at least one of the presence and location of the pest response to the trigger. Thus, upon receiving a trigger indication, the hub processing device can use hub sensors to sense additional parameters regarding the potential pest, using this to confirm the potential pest is a pest and optionally to determine additional detail such as a pest type and/or location. Once a pest has been confirmed, the hub instructs the node processing device to activate deterrents by generating respective instructions, with the node processing device responding to instructions to activate the respective deterrents, as will be described in more detail below.

The hub processing device typically determines a location of each of the nodes and uses the location of the nodes to determine the location of the pest, and/or selectively activate deterrents. Thus it will be appreciated that depending on the node which detects the proximity of the pest, this can allow the hub to pinpoint a pest location to a certain degree of accuracy, depending on factors such as spacing of the nodes and the range of the respective node sensor. Additionally, this allows the hub processing device to spatially control the activation of deterrents, allowing this to be used to activate deterrents in specific patterns and/or sequences, which can in turn be used to encourage pests to move in a direction away from the area being protected.

The manner in which the location of the nodes is determined will vary depending on the preferred implementation. For example, the location can be stored in a store during an initial configuration process, and retrieved as required, or an indication of the location can be received from the nodes, or alternatively the location of nodes can be sensed by using a hub sensor, with this being performed dynamically as required, or during configuration.

The hub processing device generally communicates with the nodes via a wireless communications channel, and in one example via a mesh or other similar network established between the nodes. This allows the hub to communicate with nearby nodes, with communications to other nodes being routed between the nodes as required, thereby minimising the transmission range required to communicate with each of the nodes. However, it will be appreciated that this is not essential and other communications techniques can be used.

As previously mentioned, the hub typically includes one or more hub sensors for use in sensing a pest. In a single instantiation of the system, only a single hub is provided to monitor several nodes, this allows the hubs to be configured with more complex and/or expensive sensors than the nodes, allowing additional information regarding pests to be collected. For example, the nodes could be configured with simple proximity or motion sensors and optionally microphones to detect movement and acoustic signals local to the node, whilst the hub could be configured with an imaging device, such as a camera, thermal imager, scanning device, higher performing acoustic sensing devices, or the like, to allow the pest to be sensed in more detail. It should be understood, however, that the nodes and the hub may include different combinations of sensors depending on the implementation, and in one example the nodes may also include cameras and microphones as per the hub. In any event, the use of a combination of different sensors allows a wider range of information regarding the pest to be collected, which can in turn assist with pest identification or classification, without overtly impacting on the price and complexity of the system. To obtain effective coverage over an area or boundary, several instantiations may be deployed.

In one particular example, the hub sensors may have a relatively limited field of view, for example in order to provide a higher degree of detection resolution. In this instance, in order to increase a degree of coverage provided by the hub sensor, the hub sensor can be a moveable sensor that can be moved so as to allow a pest to be imaged or otherwise sensed. The moveable sensor could be moved in any manner depending on the preferred implementation. For example, the entire hub or just the hub sensor could be mounted on a robot or autonomous vehicle, allowing the hub and/or hub sensor to be moved to a desired location so that the hub sensor can more effectively sense the pest. More typically however, the hub sensor is mounted on a rotatable and optionally tiltable mast or other similar structure, allowing the hub sensor to be moved until the pest is within a field of view of the hub sensor, or to provide wide area surveillance for the presence of pests, non-pest animals, and nodes.

In one example, the hub processing device uses either the pest indication and/or hub or node sensor data to determine the location of the pest and then controls the moveable sensor in accordance with the pest location. This enables a general pest location to be used to control the hub sensor, with the hub sensor position then being adjusted to allow additional sensing to be performed, for example to allow for pest identification or classification or to determine the pest location to a higher degree of accuracy. It will be appreciated that this allows the hub to be fitted with higher resolution sensing equipment, whilst allowing coverage to be provided effectively over a wide area in a cost effective manner.

Typically, the processing device determines sensed parameters from the sensor data with these including at least any one or more of a pest size, a pest shape, a pest colour, a pest thermal signature, a pest movement, a pest velocity, a pest acceleration, a pest location, a pest number, a pest concentration and a pest response. These sensed parameters can then be utilised in order to classify the pest, for example by determining a pest type, such as a class, species or the like. In this regard, different types of pest will have respective characteristics. For example, whether a pest is ground or airborne can distinguish between birds and other pests. Similarly, some birds will tend to be present as individuals whilst others may present in greater numbers such as in a flock. Pests that are cold blooded will tend to have a minimal thermal signature, whilst warm blooded pests may have a significant thermal signature, depending on the ambient conditions. It will therefore be appreciated that by comparing sensed parameters to a range of reference parameters this can allow particular types of pest to be identified. It is noted that the processing device may also determine other information in addition to the sensed parameters from the sensor data, which may further assist in classifying the pest. For example, the sensor data may include the time of day (which may be used to distinguished between diurnal and nocturnal pests) and the time of year (which could be correlated with seasonal migrations of particular pests).

Whilst this can be achieved utilising any suitable approach, in one example the processing device determines a pest signature using sensed parameters, with the signature being indicative of a magnitude or other value associated with a selected set of the parameters. The pest signature is then compared to reference signatures indicative of the identity of respective pests, which have been previously established, either through manual analysis and/or by using a classification training algorithm based on sample or live data sets.

For example, sample data sets can be obtained from multiple instances of each of a number of different types of pest and non-pests. These can then be clustered into groups, using supervised or unsupervised learning techniques, such as Principal Component Analysis (PCA), k-means or Self Organising Map (SOM) or the like. The clusters are analysed to identify particular sensed parameters that can distinguish between different clusters. A range of different analysis techniques can be utilized including, for example, regression or correlation analysis techniques, such as Partial Least Squares, Random Forest or Support Vector Machines, usually coupled to a feature reduction technique for the selection of the specific subset of sensed parameters, which can then be used to form the signature.

Sample signatures can then be created in the form of a multi-dimensional vector, with each row in the vector being indicative of a value or range of values for a respective sensed parameter. In one example, a sample vector is generated for each pest detection event, with clustering being performed to group sample vectors relating to particular pests to thereby identify reference signatures for each type of pest. For example, this could be performed using iterative global partitioning clustering algorithms and Bayesian evidence classification, support vector machines or the like, which can be used to effectively define decision boundaries in the multi-dimensional vector space, such that if a corresponding pest signature falls within the decision boundary, this indicates that the pest is of the corresponding pest type. It will be appreciated that other suitable techniques such as genetic programming, recurrent neural networks or the like, could be used.

Having determined a pest type, the at least one processing device can determine the pest deterrent strategy in accordance with the pest type, location(s) and number(s). In particular, different strategies can be defined for different pest types so that the most successful strategy can be employed for a particular pest, and simultaneous strategies can be enacted if different types of pests have been detected in the same area at the same time. For example, some pests will be scared by noise whereas others may not react to noise but be deterred by light or motion.

Whilst strategies can be defined in any appropriate way, in one example, a number of deterrent templates are stored in a data store with the processing device retrieving a respective one of the deterrent templates based on the pest type. The deterrent template is then used to determine the deterrent strategy, typically depending on one or more of the sensed parameters. For example, the deterrent template may specify the deterrents or sequences of deterrents that should be used, along with rules regarding how the sequence should be modified and/or implemented based on the respective sensed parameters. Thus, the template could indicate that a sequence of acoustic signals should be activated, and that these should be activated moving progressively towards the pest, so that the processing device uses the current pest location to generate the deterrent strategy, to thereby optimise the exit strategy for the current pest incursion. This process is typically performed by the hub processing device, although it will be appreciated that this is not essential and processing could be distributed between the hub and other processing devices, depending on the preferred implementation. It will be appreciated from the above that the deterrent template could be of any appropriate form, such as a script, program or logic sequence.

Once the deterrent strategy has been determined, the hub processing device can generate instructions, which are transferred to the respective nodes, causing the nodes to activate their deterrents in accordance with the determined strategy. Following this, the response of the pest is detected by monitoring sensor data from the hub and/or node sensors, and using the sensed parameters to assess the pest response. A wide range of different responses could be monitored depending on the preferred implementation and available sensor data. For example this could be achieved by monitoring movement or noise of the pest, or by monitoring bio-physical responses, behavioural responses, or the like.

The processing device can then selectively modify the deterrent strategy for the pest type, for example by modifying the deterrent template. It will be appreciated that modification may not be required in the event that the deterrent has been successful, although some modification may still be performed, particularly if the respective pest has a tendency to become accustomed to particular deterrents after only a few exposures. It will further be appreciated that the modification could be performed dependent on various measures of effectiveness, even if full effectiveness is achieved. For example, if one stimulus deters birds over a 20 minute period and then another deters birds immediately (say within 30 seconds) then this learning can help rank the stimulus for inclusion in future scenarios.

In order to allow modification to be performed, response data indicative of a response of the pest to a particular deterrent strategy can be stored. The deterrent strategy can then be modified using the response data so as to take into account changes in the pest responses over time. For example, the first time a pest is exposed to a particular deterrent the pest may be deterred. However, over time the pest may become accustomed to the deterrent in which case their response will gradually decrease. By examining the historical data, this can be used to make predictions regarding when the deterrent will become ineffective. Additionally, the historical data can be used to determine which deterrents have been previously tried and their relative success. This allows the processing device to selectively modify the deterrent strategy, with the goal of increasing the effectiveness.

The modification can be performed using any suitable techniques, such as using adaptive learning, machine learning, parameter modification, heuristic rules, genetic algorithms, genetic programming, recurrent neural networks, or the like. For example, different strategies could be assigned to different genes, with each strategy being scored based on the relative success of the strategy. Different combinations of genes, corresponding to different strategies could then be created and scored, allowing the processing device to predict those that are more likely to succeed. These can then be tested and scored, allowing the strategies to be adapted and progressively improved.

The deterrent templates can be retrieved from a local store, or alternatively from a remote store. In particular, this allows a number of hubs to share deterrent templates and/or strategies via a central database or other similar repository, so that particularly successful strategies can be shared. This enables a wider number of strategies to be employed to thereby more successfully scare pests. Though it can be appreciated that an effective strategy for a particular pest in one area may not be as successful to the same pest in another area. It will also be appreciated that in a similar manner sensor data and/or pest signatures can also be shared via a central repository, allowing for improvements in the identification or classification of pests, as well as allowing pest behaviours to be monitored more broadly, for example to track migration of pests or the like.

The at least one sensor can include at least one thermal sensor, one or more imaging devices in various spectral domains including colour, a proximity sensor, a motion sensor and an acoustic sensor, an ultrasound sensor, or the like. In this regard, motion and/or proximity sensors would typically be provided on each of the nodes, whilst other sensors would typically be provided in the hub, although the particular distribution will vary depending on the preferred implementation. The deterrents typically include acoustic signal generators, a light source or a motion generator, such as a controlled autonomous vehicle, or moving mechanical system, but again other deterrents could be used such as autonomous vehicles, drones, robots or the like. In one example, the deterrent may include generating a request for human presence, which could involve transmitting a message to a human user requesting that the human be present in order to deter pests manually. The deterrent strategy typically defines at least one of an acoustic signal type, an acoustic signal location, an acoustic signal sequence, a motion type, a motion location, a motion sequence, a motion object, an illumination type, an illumination location or an illumination sequence, or a request for human presence as mentioned above, although again any suitable strategy could be used depending on the deterrents available.

In some examples, deterrent strategies may be defined which do not necessarily require the activation of deterrents immediately upon detection of a pest. For instance, a particular deterrent strategy may call for secondary or tertiary detections of the same pest in preferred locations before activating. Deterrent strategies of this type may be used to deliberately permit the incursion of a pest until the pest is allowed to reach a particular location, such as a location closer to a particular deterrent or a location where a pest is in a position or state that the deterrent strategy deems to be more effective for deterring. Sophisticated deterrent strategies may be used to activate selected deterrents based on the location of the pest so that the deterrents can be used to effectively guide the pest on a desirable exit path from a site. It will be appreciated that a wide range of deterrent strategies may be defined and the examples provided herein are not intended to be exhaustive.

In some examples, the system may be configured so that the at least one processing device causes the at least one deterrent to be activated in response to determining the presence of a predetermined number of pests. It should be appreciated that the system does not necessarily need to activate deterrents upon detection of a first pest, as the strategy may call for additional pest detections in preferred locations before activating deterrents. The predetermined number of pests for triggering activation of the deterrent may therefore be set depending on the preferred detection and deterrent strategies.

Accordingly, in some implementations, the method for deterring pests may involve the following. First the at least one processing device determines a presence of pests in accordance with sensor data from at least one sensor. This may require detection of a single pest or multiple pests depending on requirements. In response to detecting the predetermined number of pests, the at least one processing device operates to determine a deterrent strategy. The at least one processing device then causes at least one deterrent to be activated in accordance with the deterrent strategy. Next, the at least one processing device monitors a response of one or more of the pests to the activated deterrent in accordance with sensor data from the at least one sensor. Finally, the at least one processing device selectively modifies the deterrent strategy in accordance with the response of the one or more of the pests.

For the sake of explanation the following detailed examples assume that the deterrent is activated upon detection of a single pest, but it should be appreciated that embodiments of the system may be adapted to only activate deterrents upon the detection of multiple pests if required.

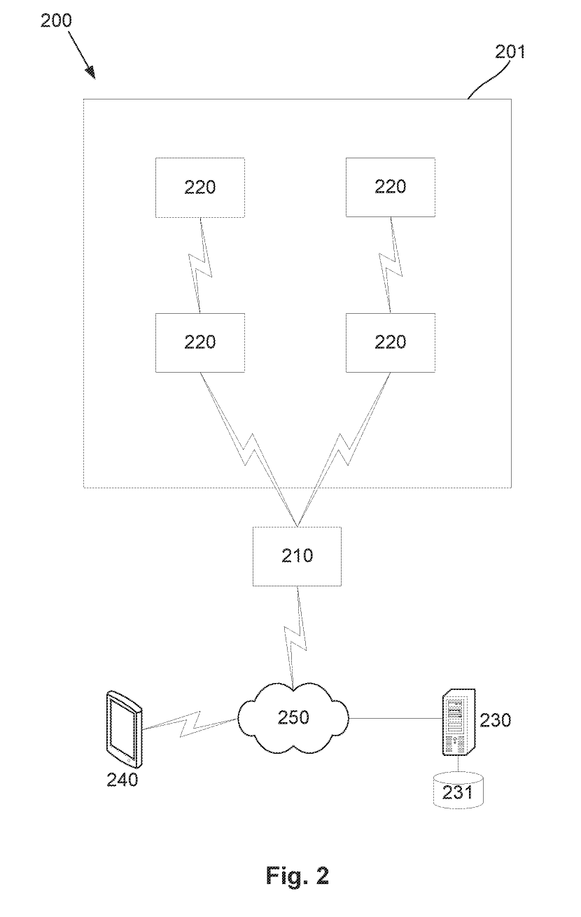

An example of a pest deterring system will now be described in more detail with reference to FIG. 2.

In this example the pest deterrent system 200 is utilised in order to protect an area of land 201, such as a field of crops, area of habitation or the like. The system includes a hub 210 wirelessly in communication with multiple nodes 220. Whilst the hub 210 could communicate directly with each of the nodes 220, more typically the nodes 220 are in communication with each other, allowing signals to be transmitted from the hub 210 to one or more of the nodes 220, and then distributed throughout the network of nodes 220 as required. This extends the range over which nodes can be provided without requiring an increase in range of the wireless communication. Whilst a single hub is shown, in practice multiple hubs can be provided as required, providing a fully scalable system and/or allowing multiple different areas to be protected.

The hub 210 may also be in communication with one or more processing systems 230, and/or a client device 240 via a communications network 250, such as the Internet, and/or a number of local area networks (LANs). It will be appreciated that the configuration of the networks are for the purpose of example only, and in practice the hubs 210, nodes 220, processing systems 230 or client devices 240 can communicate via any appropriate mechanism, such as via wired or wireless connections, including, but not limited to mobile networks, phone satellite networks, private networks, such as an 802.11 networks, the Internet, LANs, WANs, or the like, as well as via direct or point-to-point connections, such as Bluetooth, or the like.

It will also be appreciated that one or more of the components can be distributed over a number of geographically separate locations, for example by using processing systems provided as part of a cloud based environment. Thus, the above described arrangement is not essential and other suitable configurations could be used.

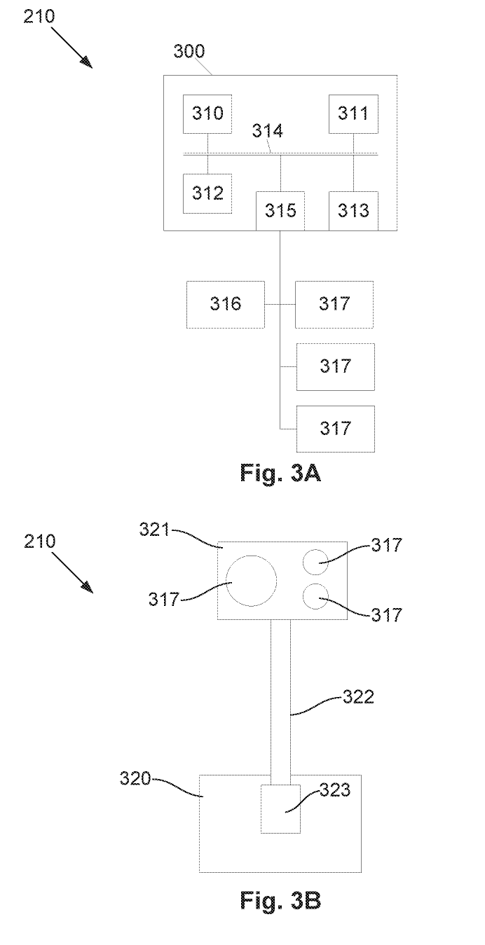

An example of the hub 210 is shown in more detail with reference to FIGS. 3A and 3B.

In this example, the hub 210 includes a hub processing system 300 having at least one microprocessor 310, a memory 311, an optional input/output device 312, such as a keyboard and/or display, and an external interface 313, interconnected via a bus 314 as shown. In this example the external interface 313 can be utilised for connecting the hub 210 to peripheral devices, such as the communications networks 250, or the like. The processing system 300 further includes a second internal interface 315, which is connected to a number of hub sensors 317 and a motor controller 316, which is used to allow rotation and optionally tilting of the hub sensors 317 to be controlled.

In use, the microprocessor 310 executes instructions in the form of applications software stored in the memory 311 to allow the required processes to be performed. The applications software may include one or more software modules, and may be executed in a suitable execution environment, such as an operating system environment, or the like.

Accordingly, it will be appreciated that the hub processing system 300 may be formed from any suitable processing system, such as a suitably programmed client device, PC, or the like. In one particular example, the hub processing system 300 is a standard processing system such as an Intel Architecture based processing system, which executes software applications stored on non-volatile (e.g., hard disk) storage. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 3B, in one example the physical configuration of the hub includes a base unit 320 and a sensor array 321 supported by a shaft 322 which is rotatably mounted to the base unit 320 and controlled by a motor 323. In use, the motor controller 316 can be used to control operation of the motor 323, allowing the sensor array 321 to be orientated so as to allow a field of view of the sensors 317 to be adjusted. This can be used to increase the overall effective coverage area of the hub 210, and also allow the hub to focus on particular locations, in order to increase a resolution of detection, for example to aid identification of pests.

The hub typically also incorporates or is coupled to a power supply, such as a mains electrical supply, or a battery optionally in combination with a generator such as a wind turbine or solar panel, which is able to charge the battery as required thereby making the hub self-powered.

The hub can also include deterrents, in addition to those provided on the nodes, with these being used to supplement the node deterrents. In one example, the hub deterrent may be provided in the form of a light source capable of directing a light beam towards a detected pest. In a further example, the hub could include deployable sensors and/or deterrents, for example in the form of autonomous vehicles, such as drones, which can be deployed as required in order to provide sensing and/or deterrent functionality. For example, in the event that a potential pest is detected, the hub sensors could be deployed to a general location of the potential pest, allowing additional sensing to be performed, to thereby identify the pest and/or determine the pest location with greater accuracy.

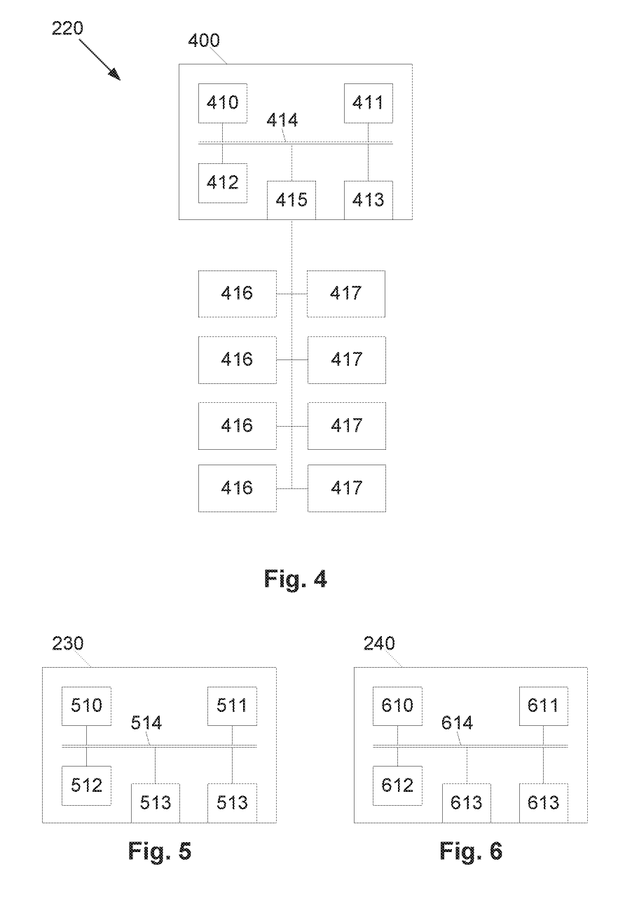

An example of one of the nodes 220 is shown in more detail with reference to FIG. 4.

In this example, the node 220 includes a node processing system 400 having at least one microprocessor 410, a memory 411, an optional input/output device 412, such as a keyboard and/or display, and an external interface 413, interconnected via a bus 414 as shown. In this example the external interface 413 can be utilised for wirelessly connecting the node 220 to the hub 210. The processing system 400 further includes a second internal interface 415, which is connected to a number of deterrents 416, such as speakers, lights, mechanical devices for creating movement, or the like, and a number of node sensors 417, such as a proximity and/or movement sensor, imaging device, microphone, or the like. It should be appreciated, however, that some the nodes 220 may not necessarily include deterrents 416. For instance, in some examples, at least some nodes 220 may be provided without deterrents 416 and used for early detection of pests to prepare (activate) the system for potential incursions, with deterrents being provided in other nodes 220 and/or in the hub.

In one particular example, the node includes a number of proximity sensors, each of which has a respective field of view arranged to provide coverage over a respective sector. For example, four proximity sensors could be provided, each of which detects pests in a respective quadrant, thereby allowing an approximate pest location to be determined based on which sensor detects the pest. However, it will be appreciated that other sensors could be used depending on the preferred implementation.

In use, the microprocessor 410 executes instructions in the form of applications software stored in the memory 411 to allow the required processes to be performed. The applications software may include one or more software modules, and may be executed in a suitable execution environment, such as an operating system environment, or the like.

Accordingly, it will be appreciated that the node processing system 400 may be formed from any suitable processing system, but is typically a low powered computing system. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

The node typically also incorporates a power supply, such as a battery and may be coupled to a generator, such as a wind turbine or solar panel, which is able to charge the battery as required, thereby making the node self-powered.

The nodes could be static devices, but alternatively could be incorporated into, or form, an autonomous vehicle, such as a drone. In this instance, the node could include a static base containing a power supply, with the drone being able to dock with the base for recharging and performing detection of potential pests, and with the drone being used to provide a mobile deterrent, and optionally mobile detection.

An example of a suitable processing system 230 is shown in FIG. 5.

In this example, the processing system 230 includes at least one microprocessor 510, a memory 511, an optional input/output device 512, such as a keyboard and/or display, and an external interface 513, interconnected via a bus 514 as shown. In this example the external interface 513 can be utilised for connecting the processing system 230 to peripheral devices, such as the communications networks 250, databases, other storage devices, or the like. Although a single external interface 513 is shown, this is for the purpose of example only, and in practice multiple interfaces using various methods (e.g. Ethernet, serial, USB, wireless or the like) may be provided.

In use, the microprocessor 510 executes instructions in the form of applications software stored in the memory 511 to allow the required processes to be performed. The applications software may include one or more software modules, and may be executed in a suitable execution environment, such as an operating system environment, or the like.

Accordingly, it will be appreciated that the processing system 230 may be formed from any suitable processing system, such as a suitably programmed client device, PC, web server, network server, or the like. In one particular example, the processing system 230 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 6, in one example, the client device 240 includes at least one microprocessor 610, a memory 611, an input/output device 612, such as a keyboard and/or display, and an external interface 613, interconnected via a bus 614 as shown. In this example the external interface 613 can be utilised for connecting the client device 240 to peripheral devices, such as the communications networks 250, databases, other storage devices, or the like. Although a single external interface 613 is shown, this is for the purpose of example only, and in practice multiple interfaces using various methods (e.g. Ethernet, serial, USB, wireless or the like) may be provided.

In use, the microprocessor 610 executes instructions in the form of applications software stored in the memory 611 to allow communication with the processing system 230 and or the hub 210.

Accordingly, it will be appreciated that the client devices 240 may be formed from any suitable processing system, such as a suitably programmed PC, Internet terminal, lap-top, or hand-held PC, and in one preferred example is either a tablet, or smart phone, or the like. However, it will also be understood that the client devices 240 can be any electronic processing device such as a microprocessor, microchip processor, logic gate configuration, firmware optionally associated with implementing logic such as an FPGA (Field Programmable Gate Array), or any other electronic device, system or arrangement.

Examples of the pest deterrent processes will now be described in further detail. For the purpose of these examples it is assumed that actions performed by the hub 210 and nodes 220 are performed by the respective processing systems 300, 400 and in particular by the respective processors 310, 410 in accordance with instructions stored as applications software in the memory 311, 411. It is assumed that the processing system 230 is a server, with actions performed by the processing system 230 being performed by the processor 510 in accordance with instructions stored as applications software in the memory 511, and that the client device 240 is a user device to allow user interaction with the system, with actions performed by the client device 240 being performed by the processor 610 in accordance with instructions stored as applications software in the memory 611 and/or input commands received from a user via the I/O device 612.

However, it will be appreciated that the above described configuration assumed for the purpose of the following examples is not essential, and numerous other configurations may be used.

In initially configuring the system, the hub 210 and nodes 220 are typically positioned to provide coverage for the area of land. In this regard, the hub and node sensors 317, 417 have respective fields of view 710, 720, with the hub 210 and nodes 220, being arranged to provide field of view coverage across the entire area of interest, or selected parts of the area.

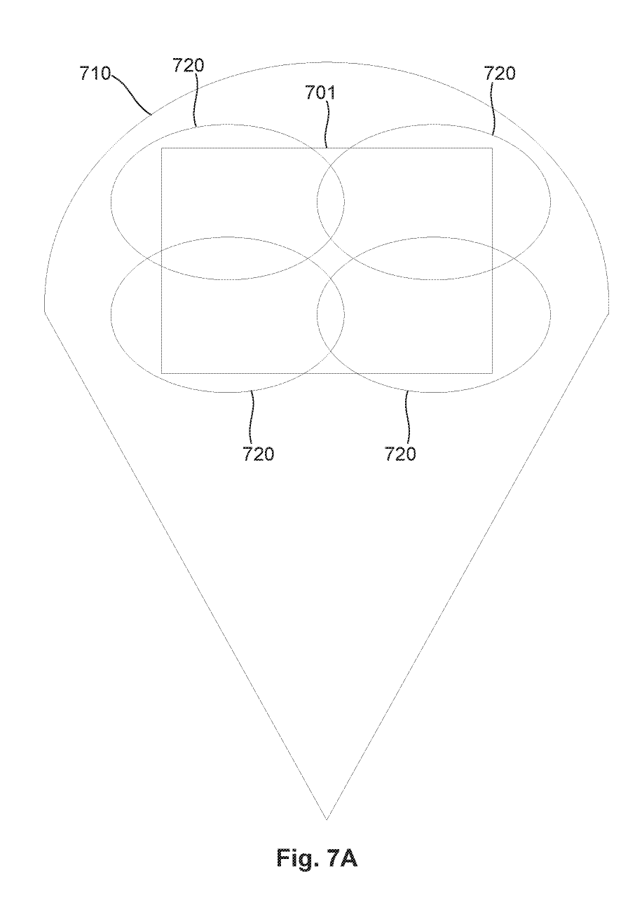

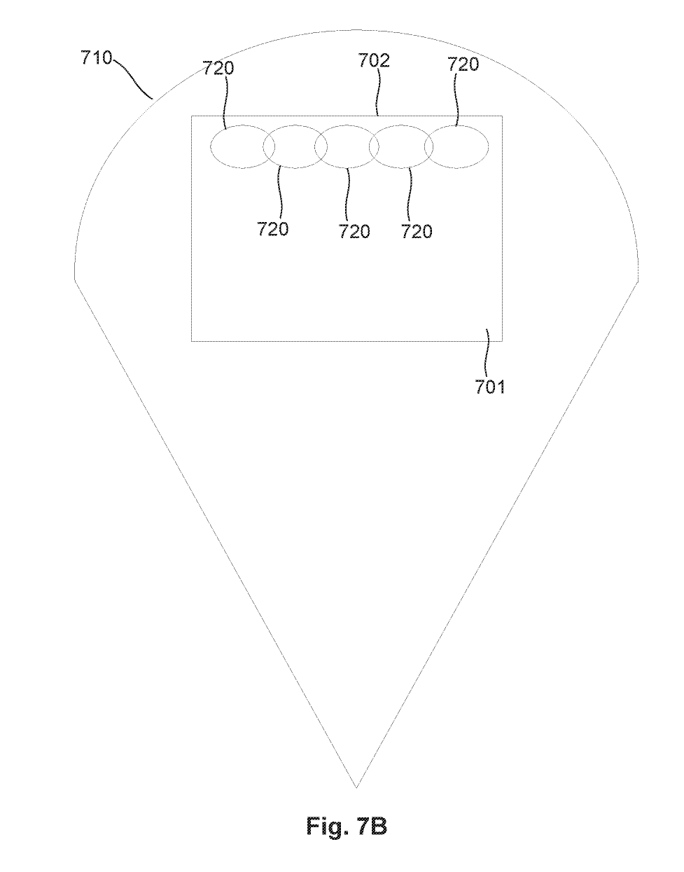

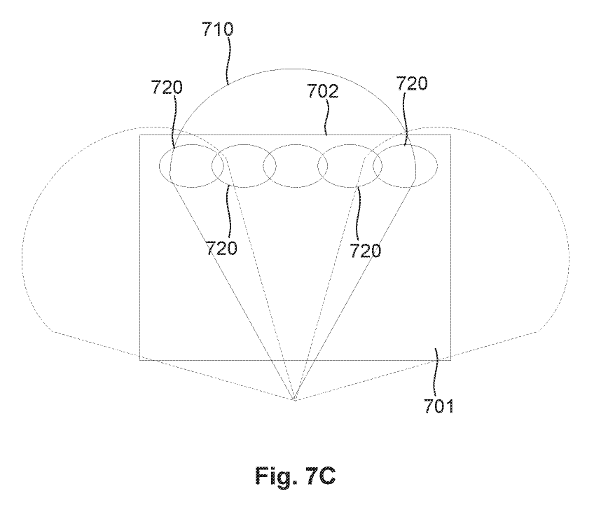

In the example of FIG. 7A, the nodes 220 are positioned to provide complete or substantially complete coverage over the entire area 701. The hub 210 is then positioned offset from the nodes 220, outside of the area, so that the hub field of view 710 overlaps and extends beyond the area 701, to thereby provide coverage beyond that afforded by the node fields of view 720 provided by the nodes 220 alone, whilst acting to also provide additional sensor coverage within the area. This arrangement is applicable for situations in which coverage is required relatively uniformly throughout the area, and where incursions occur either aerially, or from any of the field boundaries.

In the example of FIG. 7B, the nodes 220 are positioned along a boundary 702 of the area 701, supplemented by the field of view 710 of the hub 210. This is useful for situations in which incursions are only likely along the particular boundary of the area, allowing this to be targeted by the nodes, thereby reducing the number of nodes required to protect the respective area.

In the example of FIG. 7C, the field of view 710 of the hub 210 does not extend over the entire area, but can be moved as shown by dotted lines to allow complete coverage to be provided, whilst allowing sensing within the area at a higher resolution.

It will be appreciated from this that a wide range of different node and/or hub configurations can be used in order to provide appropriate sensing and/or deterrent coverage over a wide variety of different areas depending upon the preferred implementation. For example, nodes could be positioned with node fields of view 720 that do not overlap. In this instance, the hub can be adapted to provide additional coverage between the node fields of view 720, either statically, or by rotating the hub sensors, to ensure adequate overall coverage is provided.

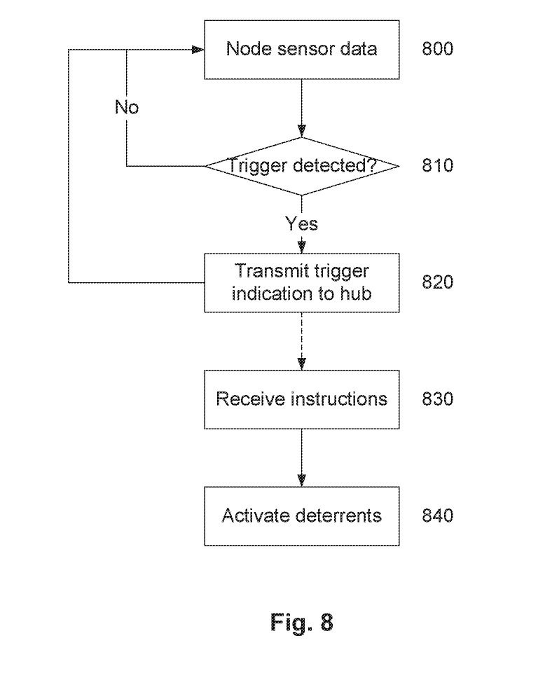

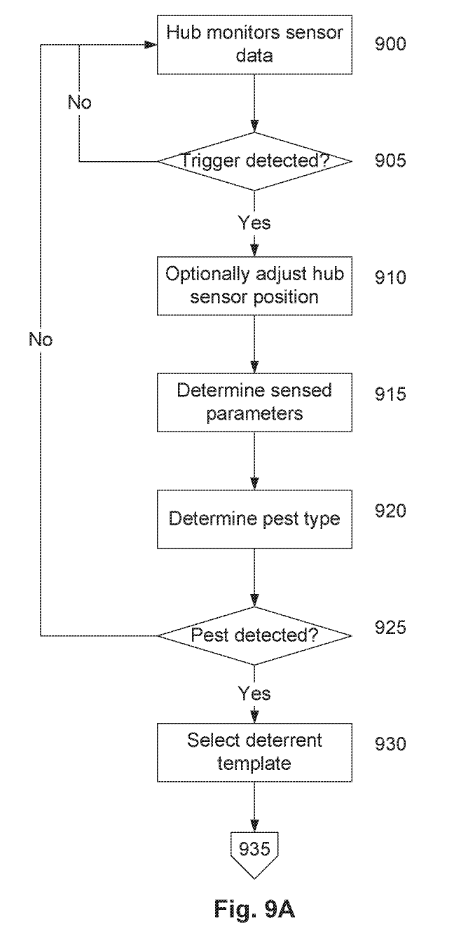

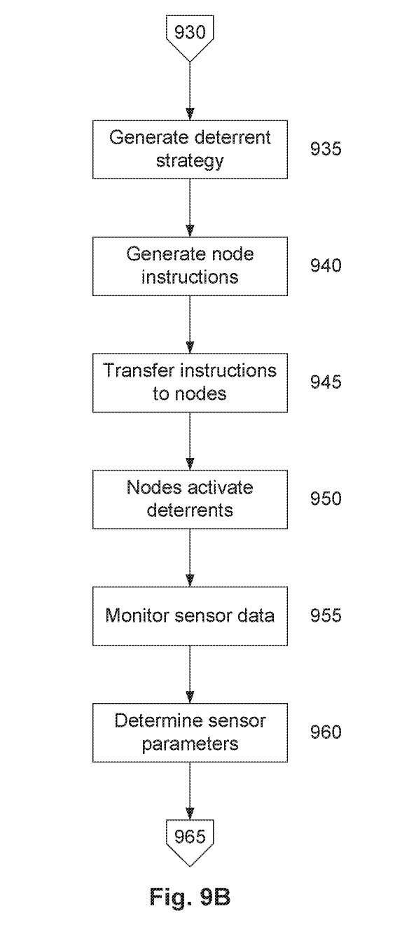

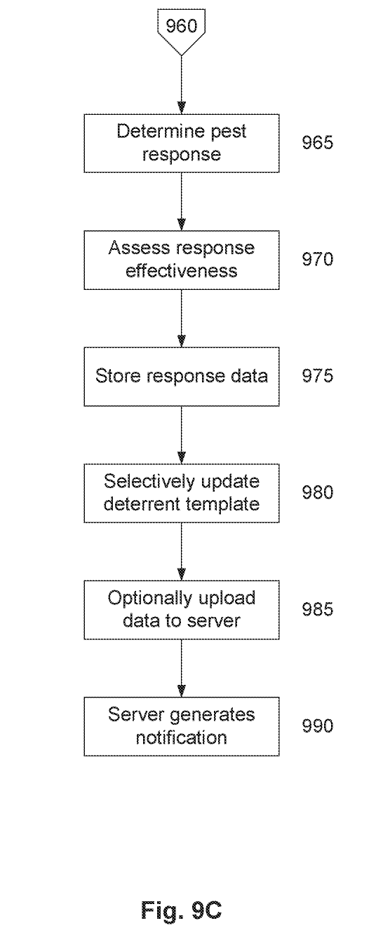

An example of operation of the system will now be described in more detail with reference to FIGS. 8 and 9A to 9C.

In particular, operation of the node will now be described with reference to FIG. 8.

In this example, at step 800 the node processor 410 monitors sensor data from the node sensors 417 and determines if a potential pest has been detected, for example if movement and/or proximity of an animal has been detected at step 810. If so, the node processing device causes a trigger indication to be transmitted to the hub 210 at step 820. In this regard, the trigger indication will typically include an indication of an identity of the node and of which node sensor detected the potential pest, thereby allowing an approximate location of the potential pest to be determined by hub. The trigger indication could additionally and/or alternatively include sensor data collected by the node sensors, depending on the preferred implementation and the nature of the node sensors. In either case, the process can then return to step 800 allowing further sensor data to be collected.

It will be appreciated that this process can be performed continuously. However, more typically, this is performed periodically, such as every few seconds, so that the nodes can continue to monitor and determine if potential pests are present or not, whilst minimising power usage. In either case, this ensures transmissions to the hub are only required in circumstances in which potential pests are detected, thereby reducing data transmission and hence power usage requirements of potentially both the sensor nodes and the hub.

Concurrently with this, the node will operate to process instructions received from the hub 210. In this regard, at step 830 instructions are received by the node processor 410, from the hub 210, with the processor 410 responding to these to selectively activate deterrents as required at step 840.

Accordingly, it would be appreciated from this that in the absence of any potential pests the node will typically await instructions from the hub whilst monitoring for triggers, such as proximity detection events. If a potential pest is detected by the node 220, the node 220 provides a pest indication to the hub 210, which then assesses the response that is required. Regardless of how potential pests are detected, the hub 210 can instruct any of the nodes 220 to activate deterrents.

An example of operation of the hub 210 will now be described in more detail with reference to FIGS. 9A to 9C.

In this example, at step 900 the hub 210 monitors sensor data from the hub sensors 317 and/or trigger indications received from the nodes 220 to determine if a potential pest has been detected, at step 905. In this regard, a trigger could correspond to a proximity event, or any change in sensed parameters that could be indicative of the presence of a pest. If not, the process returns to step 900.

If a potential pest has been detected based on data from one of the hub sensors 317 or an indication from the nodes 220, the hub processor 310 can adjust the position of the hub sensors 317, at step 910, allowing the hub sensors 317 to be used to collect additional information, such as to allow the potential pest to be imaged or the like.

At step 915 the hub determines sensed parameters from the sensor data and uses these to determine a pest type at step 920. As previously described, this can be achieved in any suitable manner, such as by generating a pest signature using the sensed parameters and then comparing the pest signature to reference signatures indicative of different types of pests. Alternatively, this could include pattern matching, heuristic approaches or the like, depending on the preferred implementation.

As part of this process, at step 925 it may be determined that the trigger does not relate to a pest, for example if a non-pest animal has been detected, or if the trigger is classified as another event, such as movement of crops in the wind or the like. If a pest is not detected, the process can return to step 900, otherwise, the identity of the pest is used to select a deterrent template at step 930.

The deterrent template includes rules specifying how the deterrent strategy should be generated. For example, this could specify particular sequences of acoustic signal and/or lights to be activated, as well as information regarding where this should be performed relative to the pest. For example, this could be performed to ensure the pest is located between the deterrent and the nearest area boundary, to thereby attempt to herd the pest towards the boundary.

The hub processor 310 utilises the template to generate a deterrent strategy at step 935, for example using sensed parameters, such as the pest location and the instructions defined in the template. The hub processor 310 then uses the deterrent strategy to generate node instructions at step 940, with these then being transmitted to each of the nodes at step 945, to thereby cause the nodes to activate the respective deterrents at step 950. However, in alternative embodiments, the deterrent strategy may be determined using one or more node processors 410 or using other processing systems provided as part of a cloud based environment. In one cloud processing example, the deterrent strategy can be merged with other data.

Turning back to the present example, at step 955 the hub will then continue to monitor sensor data, and any pest indications received from nodes, determining sensed parameters at step 960, allowing these to be used to assess a pest response at step 965. In particular, the pest is monitored to determine whether the pest has responded to the deterrent strategy, for example, to determine whether the pest's behaviour has changed. In this regard, the response could be assessed in terms of a number of different measures, including a degree of success, such as whether the pest has been deterred, partially deterred or not deterred, a rate of the response, a time before the pest returns, or the like. The hub processor 310 will use this information to assess the effectiveness of the response at step 970, before storing response data at step 975 and using this to selectively update the deterrent template at step 980.

As previously described the manner in which the deterrent strategies are updated will vary depending upon the preferred implementation and could include any adaptive approach, such as machine learning, genetic algorithms, or the like. For example, individual deterrents could be assigned to respective genes, with each gene being assigned scores based on the relative effectiveness of the deterrent for the respective pest. Different combinations of genes, corresponding to different deterrent strategies are generated and scored, with this being used to select strategies that are likely to work. Respective modifications can then be made to the template, and these strategies tested and adapted iteratively moving forward.

Any data collected during the above described process can be uploaded to the server 230 at step 985, including pest indications, sensed parameters, details of pests sensed, the deterrent strategies used, the relative success of the strategies and any modified templates created. This can allow data from multiple of different sites to be analysed collectively, which can further assist in identifying pests and determining deterrent strategies. For example, successful strategies can be stored in a template database 231, allowing these to be retrieved by other hubs and implemented as required. It will be appreciated that having multiple different sites trying different strategies increases the likelihood of successful strategies being found.

Furthermore, once identified, these can be shared amongst different hubs 210, thereby increasing the effectiveness of the deterrent at each location. For example, this enables a library of strategies that have worked before pests have become accustomed to be created, so that hubs 210 can access these and use them prior to pest becoming accustomed in the local area. It will also be appreciated that in a similar manner, at least some of the functionality performed by the hub, such as determination and/or modification of response strategies, could be performed by the server 230.

It should be understood that existing successful deterrent strategies from one implementation of the system may be used as a basis for generating new deterrent strategies for new sites or species in other implementations of the system. For example, when implementing the pest deterrent system for a new site or species, existing successful deterrent strategies can be used under the assumption that a species will react similarly despite regional differences. This may give the system a potentially functional starting point or at least a knowledgeable foundation to apply deterrent strategies.

Additionally, the server 230 can be used to make information available to end users via the client devices 240 at step 990. This could include allowing users to interrogate information, such as to view details of different pests detected at one or more sites, the deterrents used and the relative success. This information could be accessed on demand. However, additionally the server 230 could be adapted to push notifications to the client device 240, depending on the particular circumstances. For example, a user can establish a user profile that specifies they are to be notified if a particular pest is detected. In this instance, as soon as the pest is detected, the hub 210 can notify the server 230, which in turn forwards an alert, such as an SMS message to the user, alerting them to the pest, and allowing them to take follow-up action.

Accordingly, the above described system provides a mechanism for adaptively deterring pests. In one example, this is achieved by identifying pests, and then selecting a deterrent strategy based on the identified pest. Following this, responses of the pest can be monitored, with this being used to modify the pest deterrent strategy, so this is adapted iteratively over time, thereby maximising the effectiveness of the strategy, whilst preventing pests becoming desensitised to the deterrents.

In one specific example, the system provides a smart autonomous system for deterring pest animals (such as cockatoos, galahs, foxes, kangaroos etc.) from farming or agricultural assets such as orchards (e.g. berry, grape, nut, fruit), crops (e.g. cereal, textile), domestic animals (e.g. pigs, sheep, cattle) and areas where pest animals can come into direct or indirect contact with domestic animals or people (dams, public drinking fountains). However, it will be appreciated that the system could be used with a wide range of animals, for a variety of purposes.

The system typically includes a network of one or more sensor/actuator nodes, and a hub including a camera array. Additional systems can be added to an area to extend coverage without a loss of generality.

Each sensor/actuator node (termed ‘node’ for short) typically includes a solar powered, low power microcomputer, a communication device, a motion detector, and a suite of programmable deterrents. In one example, each node includes a motion detector in the form of a Passive Infrared Sensor (PIR) sensor, which will trigger on any animal-sized object movement that provides a heat signature greater than the background through a programmable threshold. These typically have an effective range between 5 m-15 m, so several may be needed to cover the asset area, or perimeter around the asset. Each node also has animal deterrents such as a selection of lights and acoustics (including ultra, audible, and infrasound) with programmable intensities and frequencies. These may be off-the-shelf units or program-controlled devices. Deterrents are controlled by their sensor node.

The hub typically includes a suite of cameras that range from thermal infrared to colour vision, an on-board computer and ability to communicate to the sensor nodes. The cameras are aligned to view the same area, such that features in each camera's image can be matched to the other cameras' image features to allow for cross-verification and validation of the animals. Alternatively, it can consist of one or more imagers, such as ultraviolet, visible or infrared imagers, providing up to 360 degree coverage. It has on-board programs, for detecting and classifying animals observed in its cameras' fields of view. The thermal camera is useful for identifying warm-blooded animals when the surrounding environment has a different ambient temperature, which is typical during night-time when the colour cameras may be ineffective. The hub can be powered from an external power supply such as a battery and recharged through solar or wind power or similar.

When the system is operational, both the sensor nodes' PIRs and the hub's cameras are used to detect movement indicative of an animal in the area being monitored. As the sensor nodes will be closer to the animal, they will typically be the first detectors, with a positive trigger being sent to the hub as to which node and where the detection occurred. The hub can focus on these locations in the images to obtain more detailed information about the trigger object to confirm if it is an animal, and which type. If the hub and/or node confirms it is a pest animal, a signal is sent back to the nodes to activate the currently selected deterrent (e.g. lights or acoustics). The hub will continue to monitor the area and record the activities and reaction of the target and any other nearby animal. If the deterrent appears to have no effect on the target, another signal is sent to the sensor nodes to try a different deterrent or deterrent combination. As such, the system can adapt to an animal that has habituated to particular deterrents, unlike typical deterrent systems. Furthermore, it also has the ability to actuate several nodes' deterrents at the same or staged times to form a temporal/spatial heterogeneous deterrent landscape.

As an extension to the system, autonomous robots may be included in the system. The robots act as a mobile deterrent either by their dynamic presence, or by on-board deterrents. They can be activated by the hub when it is deemed the current suite of deterrents is no longer effective. A physical presence by a person or robot is needed occasionally to reinforce the deterrents being used as a potential threat to a pest animal. Robots may be either ground-based or unmanned air vehicles (UAVs).

Existing systems typically use pre-programmed or reactive methods to activating deterrents, resulting in pests rapidly becoming accustomed to the deterrents used, rendering these unsuccessful. Conventional systems are generally only a simple static device, or basic electronic device with limited adjustability, often needing to be manually adjusted to ensure sufficient deterrent novelty.

In contrast, the current proposed system provides a low power usage approach in which deterrents are activated on demand, reducing power usage and the likelihood of pests become accustomed to the deterrent. Additionally, the system can adapt to the pest's reaction or lack of reaction to deterrents, targeting particular deterrents (or combinations of deterrents) to particular types of pest. The system can maintain a deterrent strategy and response history, using this to direct future development of improved strategies using intelligent machine learning or other similar adaptive approaches. It will be appreciated from this that a range of different deterrents (e.g. lights, acoustic signal) can be combined and adjusted in situ to create a ‘deterrent landscape’, with this being implemented using a wide range of off-the-shelf or custom deterrents.

The system can be adapted to function using intelligent power usage for environment monitoring, allowing this to be used continuously in remote environments, without need for additional power supply systems.

Whilst the term ‘pest’ is used generally to refer to any form of pest, the techniques described herein are particularly applicable to vertebrate pests. In particular, the system can be adapted for vertebrate pest deterring in primary industries and public areas (e.g. water fountains). However, in addition to providing pest deterrent functionality, inherent in the collection of data, the system can have application for zoonosis host monitoring and detection (biosecurity), bio-diversity analysis of warm-blooded animals in an area being monitored, animal classification and animal behaviour monitoring/classification.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

What is claimed is:

1) A pest deterrent system including at least one processing device that:
a) determines a presence of a pest in accordance with sensor data from at least one sensor;
b) determines a deterrent strategy;
c) causes at least one deterrent to be activated in accordance with the deterrent strategy;
d) monitors a response of the pest to the activated deterrent in accordance with sensor data from at least one sensor; and,
e) selectively modifies the deterrent strategy in accordance with the response of the pest.

2) A pest deterrent system according to claim 1, wherein the system includes:
a) a plurality of nodes, each node including:
i) at least one node sensor for use in sensing a pest; and,
ii) at least one deterrent for use in deterring a pest; and,
b) a hub in communication with the nodes, the hub including the at least one processing device.

3) A pest deterrent system according to claim 2, wherein the pest deterrent system is adapted to protect an area of land and wherein the nodes are at least one of:
a) spaced throughout the area; and,
b) spaced along at least part of a boundary of the area.

4) A pest deterrent system according to claim 2 or claim 3, wherein each node includes a node processing device that:
a) detects a trigger indicative of a potential pest in accordance with signals from the at least one node sensor; and,
b) provides a trigger indication indicative of the presence of the potential pest to the hub.

5) A pest deterrent system according to claim 4, wherein the node processing device:
a) determines a location of the potential pest using the sensor data; and,
b) generates the trigger indication in accordance with the location of the potential pest.

6) A pest deterrent system according to any one of the claims 2 to 5, wherein each node includes a node processing device that, in response to instructions from the hub selectively activates at least one deterrent.

7) A pest deterrent system according to any one of the claims 2 to 6, wherein the hub includes a hub processing device, and wherein the hub processing device:
a) determines at least one of a presence and location of a pest at least one of:
i) using sensor data from at least one hub sensor; and,
ii) at least partially in accordance with a trigger indication received from a node; and,
b) generates instructions to cause nodes to selectively activate at least one deterrent in accordance with at least one of the presence and location of the pest.

8) A pest deterrent system according to claim 7, wherein the hub processing device:
a) determines a location of each of the nodes; and,
b) uses the location of the nodes to at least one of:
i) determine a location of a pest; and,
ii) selectively activate deterrents.

9) A pest deterrent system according to claim 8, wherein the hub processing device determines a location of each of the nodes by at least one of:
a) retrieving a defined location from a store;
b) receiving an indication of a location from the nodes; and,
c) sensing a location of each of the nodes.

10) A pest deterrent system according to any one of the claims 2 to 9, wherein the hub communicates with the nodes via a wireless mesh network established using the nodes.

11) A pest deterrent system according to any one of the claims 2 to 10, wherein the hub includes at least one hub sensor for use in sensing a pest or non-pest.

12) A pest deterrent system according to claim 11, wherein the hub sensor is a movable sensor, and wherein a hub processing device:
a) determines a location of the pest; and,
b) controls the movable sensor in accordance with the location of the pest.

13) A pest deterrent system according to any one of the claims 1 to 12, wherein the at least one processing device determines sensed parameters from the sensor data, the sensed parameters including at least one of:
a) a pest size;
b) a pest shape;
c) a pest colour;
d) a pest thermal signature;
e) a pest movement;
f) a pest velocity;
g) a pest acceleration;
h) a pest location;
i) a pest number;
j) a pest concentration; and,
k) a pest response.

14) A pest deterrent system according to any one of the claims 1 to 13, wherein the at least one processing device determines a pest type by:
a) generating a pest signature using at least one sensed parameter derived from the sensor data;
b) comparing the pest signature to a number of reference signatures indicative of the identity of respective pests; and,
c) determining a pest type in accordance with results of the comparison.

15) A pest deterrent system according to any one of the claims 1 to 14, wherein the at least one processing device:
a) determines a pest type; and,
b) determines the deterrent strategy at least partially in accordance with the pest type.

16) A pest deterrent system according to claim 15, wherein the at least one processing device:
a) retrieves one of a number of deterrent templates from a data store; and,
b) determines the deterrent strategy using the deterrent template.

17) A pest deterrent system according to claim 16, wherein each template is associated with a respective pest type and the at least one processing device:
a) retrieves the deterrent template in accordance with the determined pest type; and,
b) determines the deterrent strategy using the deterrent template and at least one sensed parameter derived from the sensor data.

18) A pest deterrent system according to claim 16 or claim 17, wherein the at least one processing device selectively modifies the deterrent strategy by modifying the deterrent template.

19) A pest deterrent system according to claim 17 or claim 18, wherein the at least one processing device retrieves the deterrent templates from at least one of:
a) a local store; and,
b) a remote store.

20) A pest deterrent system according to claim 19, wherein a number of hubs are configured to share deterrent templates via the remote store.

21) A pest deterrent system according to any one of the claims 1 to 20, wherein the at least one processing device:
a) stores response data indicative of a response of a pest to a particular deterrent strategy; and,
b) modifies the deterrent strategy using the response data.

22) A pest deterrent system according to claim 21, wherein the at least one processing device modifies the deterrent strategy using response data for a number of different responses of pests of the respective pest type.

23) A pest deterrent system according to any one of the claims 1 to 22, wherein the processing device modifies the deterrent strategy using at least one of:
a) adaptive learning;
b) machine learning;
c) parameter modification; and,
d) genetic algorithms.

24) A pest deterrent system according to any one of the claims 1 to 23, wherein the at least one sensor includes at least one of:
a) a thermal sensor;
b) a hyperspectral sensor;
c) a laser range finder;
d) an imaging device;
e) a proximity sensor;
f) a radio receiver;
g) a motion sensor; and,
h) an acoustic signal sensor.

25) A pest deterrent system according to claim 24, wherein:
a) at least one hub sensor includes at least one of:
i) a thermal sensor;
ii) an imaging device;
iii) an acoustic signal sensor; and,
iv) a radio receiver; and,
b) at least one node sensor includes at least one of:
i) a proximity sensor; and
ii) a motion sensor.

26) A pest deterrent system according to any one of the claims 1 to 25, wherein the at least one deterrent includes at least one of:
a) an acoustic signal generator;
b) a light source;
c) a motion generator; and,
d) a request for human presence.

27) A pest deterrent system according to any one of the claims 1 to 26, wherein the deterrent strategy defines at least one of:
a) an acoustic signal type;
b) an acoustic signal location;
c) an acoustic signal sequence;
d) a motion type;
e) a motion location;
f) a motion sequence;
g) a motion object;
h) an illumination type;
i) an illumination location;
j) an illumination sequence; and,
k) a request for human presence.

28) A pest deterrent system according to any one of the claims 1 to 27, wherein the at least one processing device causes the at least one deterrent to be activated in response to determining the presence of a predetermined number of pests.

29) A pest deterrent method including, in at least one electronic processing device:
a) using sensor data from at least one sensor to determine a presence of a pest;
b) determining a deterrent strategy;
c) causing at least one deterrent to be activated in accordance with the deterrent strategy;
d) using sensor data from the at least one sensor to monitor a response of the pest to the activated deterrent; and,
e) selectively modifying the deterrent strategy in accordance with the response of the pest.

30) A pest deterrent method according to claim 29, wherein the method includes:
a) providing a plurality of nodes within an area to be protected, each node including:
i) at least one node sensor for use in sensing a pest; and,
ii) at least one deterrent for use in deterring a pest; and,
b) providing a hub in communication with the nodes, the hub including at least one processing device.

31) A method according to claim 29 or claim 30, wherein the method is performed using the system of any one of the claims 1 to 28.
